(19) United States
(12) Patent Application Publication
(10) Pub. No.: US 2021/0316364 A1
(43) Pub. Date: Oct. 14, 2021

(54) IRON-BASED SINTERED SLIDING MATERIAL AND METHOD FOR PRODUCING THE SAME

(71) Applicant: Showa Denko Materials Co., Ltd., Tokyo (JP)

(72) Inventors: Daisuke FUKAE, Tokyo (JP); Ryoichi MIYAZAKI, Tokyo (JP)

(21) Appl. No.: 17/272,218

(22) PCT Filed: Aug. 28, 2019
(86) PCT No.: PCT/JP2019/033738

§ 371 Date: Feb. 26, 2021

(30) Foreign Application Priority Data
Aug. 29, 2018 (JP) PCT/JP2018/031980
Aug. 29, 2018 (JP) PCT/JP2018/031989

(51) Int. Cl. B22F 5/10; B22F 3/16; B22F 1/00

(52) U.S. Cl. CPC B22F 5/106; B22F 3/16; B22F 2302/45; B22F 2301/35; B22F 1/0011

(57) ABSTRACT

It is possible to provide an iron-based sintered sliding material excellent in the sliding performance. Provided is an iron-based sintered sliding material including, a base containing, by mass, 3 to 15% of S, 0.2 to 6% in a total amount of at least one selected from the group consisting of Cr, Ca, V, Ti, and Mg, and a remainder of Fe and inevitable impurities, sulfide particles containing at least one selected from the group consisting of Cr, Ca, V, Ti, and Mg being dispersed in the base, and pores.

### TECHNICAL FIELD

One of embodiments of the present invention relates to an iron-based sintered sliding material and a method for producing the iron-based sintered sliding material.

### BACKGROUND ART

A so-called powder metallurgy method, in which a green compact obtained by compressing and compacting raw material powder in a die is sintered enables performing compacting into a near net shape, and thus, the method is excellent in the economic efficiency because a machining allowance due to the subsequent machining is small and the material loss is small, and also because a large number of products of the same shape can be produced if a die is produced one time. The powder metallurgy method has a wide range of alloy designs because the method enables the production of special alloys that are not able to be obtained and produced by the ordinary melting. Therefore, the powder metallurgy method is widely applied to machine parts such as automobile parts.

Among machine parts, it is important for a sliding material to have a low friction coefficient and also have enough wear resistance. In particular, in a use application where a high surface pressure is applied, a sliding material formed of a copper based sintered compact such as a bronze based sintered compact or a lead bronze based sintered compact is preferably used.

In a conventional copper based sintered compact, lubricating oil is retained in pore portions of the sintered compact, and the wear resistance can be improved. Further, in the lead bronze based sintered compact, a lead phase contained in a base acts as a solid lubricant, and the wear resistance can be improved.

Patent Document 1 discloses an iron-based sintered sliding material with a metallic structure having a ferrite base in which sulfide particles are dispersed and pores, in which 15 to 30 volume % of sulfide particles are dispersed in the base, as an iron-based sintered sliding material excellent in sliding characteristics and the mechanical strength.

Patent Document 1 discloses that sulfide precipitated in the base preferably has a predetermined size to exert a solid lubricating effect. Specifically, Patent Document 1 discloses that areas of the sulfide particles having a maximum particle size of not less than 10 micrometer preferably accounts for not less than 30% of areas of all sulfide particles.

Patent Document 2 discloses a machinable sintered member in which MnS particles having a particle size of not more than 10 micrometer are uniformly dispersed in crystal grains over the entire face of a base structure, as a sintered member for improving the machinability while maintaining the strength.

### CITATION LIST

### Patent Document

Patent Document 1: JP 2014-181381 A

Patent Document 2: JP 2002-332552 A

### SUMMARY OF INVENTION

### Technical Problem

A lead bronze based sintered compact contains a large amount of lead, and thus, reduction of lead and the development of alternative materials are demanded to cope with environmental problems. Various materials have been investigated as materials alternative to the lead bronze based sintered compact, and the further improvements in the friction coefficient and wear resistance are desired for copper based sintered compacts. Further, the copper based sintered compact has a problem that the cost becomes high, because if the copper based sintered compact is adopted, the amount of copper used is increased.

From the disclosure of Patent Document 1, in the iron-based sintered sliding material, a particle size of each sulfide particle in the base is preferably large enough to be not less than 10 micrometer from the viewpoint of the sliding performance. In Patent Document 1, by adding iron sulfide to iron powder containing 0.03 to 0.9% by mass of Mn as inevitable impurities, sulfide particles are set to account for a predetermined volume percent of a sintered compact, and each sulfide particle is coarsen.

In Patent Document 2, MnS particles are precipitated in a sintered compact by adding MoS₂ powder to iron powder containing Mn. The Mn is an easily oxidizable component, and it is difficult to produce and obtain a raw material of an iron alloy rich in Mn.

An object of one of embodiments of the present invention is to provide an iron-based sintered sliding material with excellent sliding performance.

### Solution to Problem

One of embodiments of the present invention is as follows.

[1] An iron-based sintered sliding material, including: a base containing, by mass, 3 to 15% of S, 0.2 to 6% in a total amount of at least one selected from the group consisting of Cr, Ca, V, Ti, and Mg, and a remainder of Fe and inevitable impurities, sulfide particles containing at least one selected from the group consisting of Cr, Ca, V, Ti, and Mg being dispersed in the base; and pores.
[2] The iron-based sintered sliding material according to [1], further including: 0 to 10% of Ni.
[3] The iron-based sintered sliding material according to [1] or [2], further including: 0 to 10% of Mo.
[4] The iron-based sintered sliding material according to any one of [1] to [3], further including: 0 to 1% of graphite.
[5] A sliding part, wherein the iron-based sintered sliding material according to any one of [1] to [4] is used.
[6] A method for producing an iron-based sintered sliding material, including: adding a sulfur alloy powder B to an iron alloy powder A containing not less than 1% by mass in a total amount of at least one selected from the group consisting of Cr, Ca, V, Ti, and Mg such that an amount of sulfur accounts for 3 to 15% by mass of a final sintered compact; compressing and compacting a mixed powder obtained through the adding, and sintering a green compact obtained through the compressing and compacting at a temperature in a range from 900° C. to 1,200° C.
[7] The method for producing an iron-based sintered sliding material according to [6], wherein the mixed powder further includes not less than 3% by mass of at least one selected from the group consisting of a nickel powder and a nickel-iron alloy powder.
[8] The method for producing an iron-based sintered sliding material according to [6] or [7], wherein the mixed powder further includes 0 to 1% by mass of graphite.
[9] An iron-based sintered sliding material, including: a metal sulfide having not less than 20% of an area ratio, wherein a number of particles of the metal sulfide is not less than 8.0×10¹⁰ particles/m² per unit area.
[10] The iron-based sintered sliding material according to [9], wherein the number of the particles of the metal sulfide, each particle having a particle size of not more than 1 micrometer accounts for not less than 40% of a total number of particles of the metal sulfide.
[11] An iron-based sintered sliding material, including: a metal sulfide having not less than 20% of an area ratio, wherein the number of the particles of the metal sulfide, each particle having a particle size of not more than 1 micrometer accounts for not less than 40% of a total number of all of the particles of the metal sulfide.
[12] The iron-based sintered sliding material according to any one of [9] to [11], wherein the metal sulfide contains at least one selected from the group consisting of CrS, CaS, VS, TiS, and MgS.
[13] A sliding part, wherein the iron-based sintered sliding material according to any one of [9] to [12] is used.

### Effects of Invention

According to one of embodiments, an iron-based sintered sliding material with excellent sliding performance can be provided.

### BRIEF DESCRIPTION OF THE DRAWINGS

FIG. 1 is a graph showing the thrust sliding performance of Example.

FIG. 2 is a graph showing the radial sliding performance of Example.

FIG. 3 illustrates an image of a cross section of a sintered member of Example 1.

FIG. 4 illustrates images of cross sections of sintered members of Example 1 and Comparative Example 2.

### DESCRIPTION OF EMBODIMENTS

Although one embodiment of the present invention will be described below, the present invention is not limited by the following exemplification.

An iron-based sintered sliding material according to one of embodiments includes a base containing, by mass, 3 to 15% of S, 0.2 to 6% in a total amount of at least one selected from the group consisting of Cr, Ca, V, Ti, and Mg, and a remainder of Fe and inevitable impurities, sulfide particles containing at least one selected from the group consisting of Cr, Ca, V, Ti, and Mg being dispersed in the base, and pores.

The iron-based sintered sliding material according to one of embodiments is formed of an iron-based sintered compact.

The iron-based sintered compact contains Fe as a main component. The main component means a component that occupies more than the half of the iron-based sintered compact. The amount of Fe relative to an overall composition of the iron-based sintered compact is preferably not less than 50% by mass, and more preferably not less than 60% by mass.

The iron-based sintered compact can be produced based on a powder metallurgy method by using a raw material containing an iron powder and/or an iron alloy powder.

A porosity of the sintered compact is preferably 5 to 40%. The pores can be impregnated with lubricating oil.

A sliding part according to one of embodiments is formed by using the iron-based sintered sliding material.

The sliding part may be integrally formed of the iron-based sintered compact. If the sliding part is formed by using the combination of the iron-based sintered compact and other members, it is preferable that a region including a sliding surface of the sliding part is formed of the iron-based sintered compact.

A base of the iron-based sintered compact preferably contains a metal sulfide.

Examples of the metal sulfide may include FeS, MnS, CrS, MoS₂, VS, and the like, or a combination of these. Preferably, the metal sulfide may contain at least one selected from the group consisting of MnS, CrS, and VS. More preferably, the metal sulfide may contain at least one of CrS and VS.

In particular, the iron-based sintered compact preferably contains CrS. The CrS is derived from Cr as a raw material and is blended in the iron-based sintered compact, but by the Cr being contained in the iron powder as the raw material, the CrS comes to be finely distributed in the base and to be blended in the iron-based sintered compact as a sintered compact.

The metal sulfide contributes to a sliding characteristic as solid lubricant. A ratio of an area of the metal sulfide of the iron-based sintered compact to an area of the base is preferably not less than 20%. This enables the exposure of an appropriate amount of metal sulfide on the sliding surface of the sliding material and enables the further improvement in the sliding performance.

The ratio of the area of the metal sulfide of the iron-based sintered compact to the area of the base is preferably not more than 35%.

As how to measure the area ratio of the metal sulfide, for example, the measurement is performed in the way that the iron-based sintered compact is cut at any position, any region on a cross section of the iron-based sintered compact is corroded with methanol and mirror-polished, the cross section is processed such that a metallic structure can be exhibited, and an analysis is made on the processed cross section by using Electron probe micro analyzer (for example, “EPMA 1600” produced by SHIMADZU CORPORATION) to obtain an element analysis image. The measurement is performed based on a wavelength dispersive spectrometer (WDS) system. Measuring conditions may be set such that, for example, an accelerating voltage is 15 kV, a sample current is 100 nA, a measuring time is 5 m·sec, and an area size is 604×454 micrometers. Further, the element analysis image may be, for example, an image with a magnification of 500 times. The metal sulfide is inspected as a black particle in the base. For example, image analysis software (WinROOF produced by MITANI CORPORATION.) may be used for the image analysis.

In the iron-based sintered compact, the number of particles of metal sulfide in a region of 84.4 micrometer×60.5 micrometer is preferably not less than 500.

This enables the inclusion of a larger number of finer particles of the metal sulfide in the base of the iron-based sintered compact, and enables the exposure of a large number of fine particles on the sliding surface of the sliding material, and accordingly enables the further improvement in the sliding performance.

The number of particles of metal sulfide can be obtained by, for example, cutting the iron-based sintered compact, mirror-polishing the cross section, inspecting an image of a polished surface, and measuring the particles of the metal sulfide contained in the region of 84.4 micrometer×60.5 micrometer of the polished surface. For example, the image analysis software (WinROOF produced by MITANI CORPORATION.) can be used for the image analysis.

It is preferable that the particles of the metal sulfide are finely dispersed. The number of particles of metal sulfide of the iron-based sintered compact is preferably not less than 8.0×10¹⁰ particles/m² per unit area, and is more preferably not less than 1.0×0¹¹ particles/m².

This enables the inclusion of a larger number of finer particles of the metal sulfide in the base of the iron-based sintered compact, enables the exposure of a large number of fine particles on the sliding surface of the sliding material, and accordingly enables the further improvement in the sliding performance.

The number of particles of metal sulfide of the iron-based sintered compact is preferably not more than 1.0×10¹² particles/m² per unit area.

If the number of particles of metal sulfide increases, more than one metal sulfide may be combined to generate larger particles, and therefore, many fine particles can be contained within this range appropriately.

The number of particles of the metal sulfide per unit area can be obtained by, for example, cutting the iron-based sintered compact, mirror-polishing the cross section, inspecting the image of the polished surface, and measuring the particles of the metal sulfide contained in a predetermined measuring region of the polished surface. For example, image analysis software (WinROOF produced by MITANI CORPORATION.) may be used for the image analysis.

The number of particles of the metal sulfide of the iron-based sintered compact, each particle having a particle size of not more than 1 micrometer preferably accounts for not less than 40% of the total number of particles of metal sulfide, and more preferably accounts for not less than 50% of the total number of particles of metal sulfide.

This enables the inclusion of a larger number of finer particles of the metal sulfide in the base of the iron-based sintered compact, enables the exposure of a large number of fine particles on the sliding surface of the sliding material, and accordingly enables the further improvement in the sliding performance.

The number of particles of metal sulfide of the iron-based sintered compact, each particle having a particle size of not more than 1 micrometer may account for 100% of the total number of particles of the metal sulfide, but may be not more than 90%, because there is a possibility that coarse particles are mixed in the particles.

In this range, many fine particles can be included more appropriately.

The ratio of the number of particles of the metal sulfide, each particle having a particle size of not more than 1 micrometer can be obtained, for example, by cutting the iron-based sintered compact, mirror-polishing the cross section, inspecting the image of the polished surface, measuring a total number of particles of the metal sulfide included in any region of 84.4 micrometer×60.5 micrometer of the polished surface, and a number of particles of the metal sulfide, each particle having a particle size of not more than 1 micrometer in the same region, and by accordingly, calculating the ratio of the number of particles of the metal sulfide, each particle having a particle size of not more than 1 micrometer to the total number of the particles. For example, image analysis software (WinROOF produced by MITANI CORPORATION.) can be used for the image analysis.

The iron-based sintered compact preferably contains, by mass, 3 to 15% of S, 0.2 to 6% in a total amount of at least one selected from the group consisting of Cr, Ca, V, Ti, and Mg, a remainder of Fe and inevitable impurities.

The iron-based sintered compact may further contain 0 to 10% of Ni, 0 to 10% of Mo, 0 to 1% of graphite, or a combination of these.

A composition of the iron-based sintered compact will be described below.

3 to 15% of S

The inclusion of S in the iron-based sintered compact can cause the metal sulfide to be contained in the base. This enables the exposure of an appropriate amount of metal sulfide on the sliding surface of the sliding material and, the further improvement in the sliding performance. Not less than 0.5% of S is preferable, not less than 1% of S is more preferable, not less than 2% of S is still more preferable, and not less than 3% of S is highly preferable.

The excess S may inhibit sinterability and reduce strength. Further, S may scatter during sintering. Therefore, an amount of S may be not more than 15%, and, not more than 6% of S is preferable, not more than 5% of S is more preferable, and not more than 4% of S is still more preferable. Further, in this range, it is possible to prevent the occurrence of a single large particle due to the bonding of more than one particle of the metal sulfide, and cause finer particles of the metal sulfide to be contained in the base, to further improve the sliding performance.

Sulfur is preferably added as an unstable sulfur alloy powder, and examples of the sulfur alloy powder include iron sulfide, MoS₂ and the like.

0.2 to 6% of Cr

Normally, as the difference in values of electronegativity between each element and S is large, sulfide is more easily formed. Each value of the electronegativity (electronegativity by Pauling) of each element is as follows: S: 2.58, Mn: 1.55, Cr: 1.66, Fe: 1.83, Cu: 1.90, Ni: 1.91, and Mo: 2.16, and thus, sulfide is easily formed in the order of Mn>Cr>Fe>Cu>Ni>Mo. Therefore, sulfur bonds with a trace amount of Mn as an impurity contained in the iron powder to form MnS. Thereafter, sulfur reacts with chromium and then, chromium sulfide is precipitated. Because chromium has a high melting point, chromium does not aggregate and chromium reacts with sulfur in a state of dispersion, and thus, fine metal sulfide can be formed in the base. By Cr being not less than 0.2%, being preferably not less than 0.5%, and being more preferably not less than 1.0%, the material strength can be enhanced, and the sliding performance can be improved. Cr is preferably not more than 6%.

A phenomenon similar to that of Cr described above also occurs to each of Ca, V, Ti, and Mg, and a fine metal sulfide can be formed in the base. Each of Ca, V, Ti, and Mg is, independently, preferably 0.1 to 6.0%, more preferably 0.2 to 6%, and still more preferably 0.2 to 4%. The total amount of Cr, Ca, V, Ti, and Mg is preferably 0.2 to 6%, and more preferably 0.2 to 4%.

0 to 0.5% of Mn

Mn is present in the iron powder as an inevitable impurity. Mn is also a component that is easily oxidized, and the generation of an iron-manganese alloy that is rich in manganese is difficult. Even if the iron-manganese alloy that is rich in manganese is available, such iron-manganese alloy is expensive.

Mn can cause the fine metal sulfide to be generated in the base, but the amount of manganese of the iron-manganese alloy of a raw material powder that provides manganese is limited, and the amount of metal sulfide that can be formed in the sintered compact is also limited. Mn is preferably 0 to 0.5%.

0 to 10% of Mo

Mo has an effect of promoting sintering, causes a metallic structure, especially a ferrite phase to be stabilized, and accordingly provides a sintered compact with high strength.

By Mo being preferably not less than 0.1%, and more preferably not less than 1%, the material strength can be enhanced and the sliding performance can be improved. Mn is preferably not more than 10%.

Mo can be added as Mo powder and/or Mo alloy powder.

0 to 10% of Ni

Ni improves the hardenability of the iron-based sintered compact, and through processes of sintering and cooling, has an action of causing a hardened structure to be included in the iron-based sintered compact, and an action of being retained as austenite. In addition, Ni does not inhibit the formation of metal sulfide, mainly iron sulfide in terms of the electronegativity. If Ni is used in combination with C, the hardenability of an iron base may be improved, pearlite is made to be fine to enhance the strength, and bainite and martensite with the high strength can be easily obtained at a normal cooling rate during sintering.

By Ni being not less than 0.1%, preferably not less than 0.5%, and more preferably not less than 1.0%, the material strength can be enhanced and the sliding performance can be improved. Ni is preferably not more than 10%, and more preferably not more than 8%.

Ni can be added as Ni powder and/or Ni alloy powder.

0 to 1% of C

C is not an essential element, but if 0 to 1% of C is added, a part of C is in solid solution to Fe, and accordingly, the strength may be enhanced.

An iron-based sintered material is the remainder of Fe and may contain inevitable impurities. The iron-based sintered material may further contain at least one selected from the group consisting of minerals, oxides, nitrides, and borides that do not diffuse to the base. Examples of additives of the minerals, oxides, nitrides, and borides include MgO, SiO₂, TiN, CaAlSiO₃, CrB₂ and the like, or a combination of these.

The base of the iron-based sintered compact preferably contains at least one selected from the group consisting of ferrite, pearlite and martensite as a metallic structure. A more preferable structure to be included in the base is a metallic structure whose main composed is ferrite.

It is preferable that the particles of the metal sulfide are dispersed in the base. It is more preferable that the particles of the metal sulfide are finely dispersed in the base.

A method for producing an iron-based sintered sliding material will be described below. An iron-based sintered sliding material according to one of embodiments is not limited to a member produced based on a producing method described below.

In the method for producing the iron-based sintered sliding material according to one of embodiments, a sulfur alloy powder B is added to an iron alloy powder A containing not less than 1% by mass in a total amount of at least one selected from the group consisting of Cr, Ca, V, Ti, and Mg such that the amount of sulfur accounts for 3 to 15% by mass of a final sintered compact, a mixed powder obtained through the adding is compressed and compacted, and a green compact obtained through the compressing and compacting is sintered at a temperature in a range from 900° C. to 1,200° C.

It is preferable that each of Cr, Ca, V, Ti, and Mg is independently contained in the iron alloy powder and accounts for 0.1 to 8% by mass of the total amount of iron alloy powder. The total amount of Cr, Ca, V, Ti, and Mg preferably accounts for not less than 1% by mass of the total amount of iron alloy powder. Further, it is preferable that the sulfur alloy powder is added to the mixed powder such that the amount of sulfur accounts for 3 to 15% by mass of a final sintered compact. If iron sulfide is used for the sulfur alloy powder, iron sulfide containing not less than 35% by mass of S is preferable.

According to the producing method, by separately adding, to the raw material powder, the iron alloy powder A and the sulfur alloy powder B serving as a supply source of S, the S released by the decomposition of the sulfur alloy powder during sintering is caused to be bonded with at least one selected from the group consisting of Cr, Ca, V, Ti, and Mg in the base, and accordingly, MnS, CrS, VS, or a combination of these can be precipitated. According to such a producing method, MnS, CrS, VS, or a combination of these can be precipitated in crystal grains in the form of fine particles.

A green compact is preferably sintered such that a maximum retention temperature is in a range from 900° C. to 1,200° C.

By setting a temperature to be the temperature in the range, the sulfur alloy powder decomposes and at least one selected from the group consisting of Cr, Ca, V, Ti, and Mg in the base are bonded with S to form fine metal sulfide. Further, the diffusion of C, Ni, Mn, Cr, Cu, Mo, V and the like into Fe is promoted, and a metallic structure with a high base hardness is generated, and accordingly, the tensile strength of the iron-based sintered compact can be further enhanced.

The green compact is preferably retained at the maximum retention temperature for 10 to 90 minutes.

If a large amount of oxygen is contained in a sintering atmosphere, S decomposed from the metal sulfide bonds with oxygen, and is released as SOx gas, and accordingly, the amount of S bonded with metal of the base decreases, and therefore, it is preferable that the green compact is sintered in a vacuum atmosphere or a non-oxidizing atmosphere. As the non-oxidizing atmosphere, for example, ammonia decomposition gas, nitrogen gas, hydrogen gas, argon gas or the like having a dew point of not more than −10° C. can be used.

After being sintered, the sintered compact is preferably cooled at a cooling rate of 2° C./minute to 400° C./minute. A range from 5 to 150° C. is more preferable. The sintered compact is preferably cooled at the cooling rate from the maximum retention temperature to a temperature range from 900 to 200° C.

The iron alloy powder preferably contains at least one selected from the group consisting of Cr, Ca, V, Ti, and Mg together with Fe as a main component. The total amount of at least one selected from the group consisting of Cr, Ca, V, Ti, and Mg preferably accounts for not less than 1% by mass of the total amount of the iron powder.

The iron alloy powder may further contain C, Ni, Cu, Mo or a combinations of these. A blending amount of these elements is preferably adjusted such that a range of an overall composition of the iron-based sintered compact described above is satisfied.

S is preferably added as a sulfur alloy powder, for example, an iron sulfide powder, a molybdenum disulfide powder or the like.

Although the chemical affinity of S is low at a room temperature, S reacts highly at a high temperatures and can be combined, not only with metal, but also with non-metallic elements such as H, O, and C. When the sintered compact is produced, a compacting lubricant is generally added to the raw material powder, and in a temperature raising process of a sintering process, the volatilization and removal of the compacting lubricant, that is, so-called dewaxing process is performed. If S is imparted in the form of the sulfur powder, it is difficult to stably impart S which is necessary for forming the metal sulfide, because S is combined with components (mainly H, O, and C) generated by the decomposition of the compacting lubricant and, is released. Alternatively, if S is imparted in the form of the sulfur alloy powder, S exists in the form of iron sulfide in a temperature range (about 200 to 400° C.) where a dewaxing process is performed, and thus, S necessary for forming metal sulfide can be stably imparted, because S is not combined with components generated by the decomposition of the compacting lubricant and, S is not released.

In the temperature raising process of the sintering process, if a temperature exceeds 988° C., an eutectic liquid phase of the sulfur alloy is generated, sintering becomes liquid phase sintering, and accordingly, the growth of the neck among the powder particles is further promoted. Further, S is uniformly diffused in the iron base from the eutectic liquid phase, and thus, the particles of the metal sulfide can be more uniformly dispersed in the base and can be precipitated. Further, by at least one selected from the group consisting of Cr, Ca, V, Ti, and Mg being contained in the iron alloy powder of the raw material, these elements in the base react with S to generate a finer metal sulfide.

The mixed powder of the raw material may further contain a nickel powder, a nickel-iron alloy powder, or a combination of these.

Nickel is in solid solution to the base of the iron-based sintered compact as Ni and acts to enhance the strength of the base, and thus, nickel can be preferably used. Nickel may be added alone or alternatively, may be added as an alloy. Nickel can be added such that nickel accounts for not less than 3% by mass of the total amount of the mixed powder, and preferably nickel accounts for not less than 5% by mass of the total amount of the mixed powder.

The mixed powder may further contain 0 to 1% by mass of graphite. The mixed powder may further contain 0 to 10% by mass of Mo. The mixed powder can further contain an arbitrarily component such as a die lubricant.

Further embodiments of the iron-based sintered sliding material will be described below.

In the iron-based sintered sliding material according to a further embodiment, an area ratio of the metal sulfide is not less than 20%, and the number of particles of metal sulfide is not less than 8.0×10¹⁰ particles/m² per unit area.

In the iron-based sintered sliding material according to a still further embodiment, an area ratio of the metal sulfide is not less than 20%, and the number of particles of the metal sulfide, each particle having a particle size of not more than 1 micrometer accounts for not less than 40% of the total number of particles of the metal sulfide.

This can improve the sliding performance of the sliding material by using the iron-based sintered compact.

In the iron-based sintered sliding material according to above described further embodiment, because the area ratio of sulfide is large, and the number of particles of sulfide per unit area is large, the metal sulfide contained in the base becomes fine, and accordingly, the sliding performance can be improved.

In the iron-based sintered sliding material according to above described still further embodiment, because the area ratio of sulfide is large, and a ratio of particles of the metal sulfide, each particle having a particle size of not more than 1 micrometer is large, the metal sulfide contained in the base becomes fine, and accordingly, the sliding performance can be improved.

The iron-based sintered compact according to above-described other embodiments preferably includes a pore portion derived from a raw material such as the iron powder together with the base containing the metal sulfide. If the sliding material is used by applying lubricating oil to the sliding material, the lubricating oil is retained by the pore portion, and accordingly, the sliding performance can be further improved over a long period of time.

The iron-based sintered sliding material according to the above-described embodiments can be formed by adding the sulfur alloy powder to the iron alloy powder containing at least one selected from the group consisting of Cr, Ca, V, Ti, and Mg, compressing and compacting the obtained mixed powder, and sintering the obtained green compact to finely disperse the metal sulfide in crystals of the sintered compact.

### EXAMPLES

Examples of the present invention will be specifically described below, but the present invention is not limited to these examples.

### Production Example 1

### Example 1

Raw material powder A: Iron alloy powder containing, by mass, 3% of Cr, 0.5% of Mo, 0.5% of V, and a remainder of Fe

Raw material powder B: Iron sulfide containing 35% by mass of S

Raw material powder C: Ni powder

Raw material powder was obtained by mixing 10% by mass of powder B, 5% by mass of powder C, and a remainder of the powder A.

The raw material powder was compacted at a compacting pressure of 600 MPa to produce a ring-shaped green compact. Then, a sintered member of Example 1 was produced by sintering the green compact at 1130° C. in a non-oxidizing gas atmosphere.

The sintered member was cut and, a chemical composition of a base was analyzed in a cross section. The results are shown in Table 1.

The area ratio of the metal sulfide in the sintered member was obtained by cutting the obtained sample, mirror-polishing the cross section to inspect the cross section, measuring the area of the base part except for pores and the area of metal sulfide by using image analysis software (WinROOF produced by MITANI CORPORATION.), and calculating the area (%) of metal sulfide occupying in the area of the base. A measuring region was set to be 84.4 micrometer×60.5 micrometer.

The metal sulfide was inspected as a black particle in the base when the cross section was inspected.

The number of particles of metal sulfide in a region of 84.4 micrometer×60.5 micrometer was obtained by inspecting the cross section of the sintered member and analyzing images in the same way as how the above area ratio was obtained. The number of particles of metal sulfide per unit area was calculated.

The number of particles of the metal sulfide, each particle having a particle size of not more than 1 micrometer occupying in the total number of particles of metal sulfide was obtained by inspecting the cross section of the sintered member, and analyzing images in the same way as how the above described area ratio was obtained.

The maximum particle size of each particle of metal sulfide was measured with a circle equivalent diameter of conversion of a value into a diameter of a circle having an area that is equal to the obtained area of each particle. If two or more particles of metal sulfide are bonded, the bonded metal sulfide is used as one metal sulfide, and the circle equivalent diameter was obtained from the area of the metal sulfide.

The results are shown in Table 2.

### Comparative Example 1

Except that a mixed powder of JIS standard LBC3 was used, in the same manner as in Example 1, a ring-shaped green compact was produced, and the green compact was sintered at 800° C. in a non-oxidizing gas atmosphere to produce a sintered member of Comparative Example 1.

A chemical composition of the base of the sintered member was measured as in Example 1. The results are shown in Table 1.

TABLE 1
Chemical composition of base

| Unit: % | | | | | | |
|---|---|---|---|---|---|---|
| by mass | Cr | Mo | V | Ni | S | Fe |
| Example 1 | 2.6 | 0.3 | 0.3 | 4.5 | 3.6 | Remainder |
| Unit: % | | | | | | |
| by mass | Cu | | Sn | | Pb | |
| Comparative | 88.2 | | 6.7 | | 5.0 | |
| Example 1 | | | | | | |
| Unit: % | | | | | | |
| by mass | Cr | Mo | V | Ni | S | Fe |
| Comparative | — | 2.0 | — | — | 1.5 | Remainder |
| Example 2 | | | | | | |

TABLE 2
Physical properies

| | | Number of | Number of particles of |
|---|---|---|---|
| | Average area | particles of | metal sulfide having |
| | ratio of metal | metal sulfide | particle size of not |
| | sulfide (%) | (number/m²) | more than 1 μm |
| Example 1 | 20 | 1.2 * 10¹¹ | 60 |
| Comparative | 10 | 3.0 * 10⁸ | 0 |
| Example 2 | | | |

### (Evaluation)

A sintered member of the following dimensions was produced in the same manner as described above, and the following evaluations were performed.

“Thrust Sliding Performance”

A disc-shaped sintered member with a diameter of 35 mm and a thickness of 5 mm was prepared.

A ring-shaped mating material made by FSD having an outer diameter of 25 mm, an inner diameter of 24 mm, and a thickness of 15 mm was prepared.

A sliding test was performed under the following conditions by using a ring on disk friction wear tester, and a friction coefficient was measured.

Peripheral Velocity: 0.5 m/sec

Surface Pressure: 1, 2, . . . , 20 MPa

Time: 5 min at each surface pressure

Oil Type: Oil VG 460 (dropping)

The wear amount (micrometer) of the disc and the ring (FCD) before and after the test was measured.

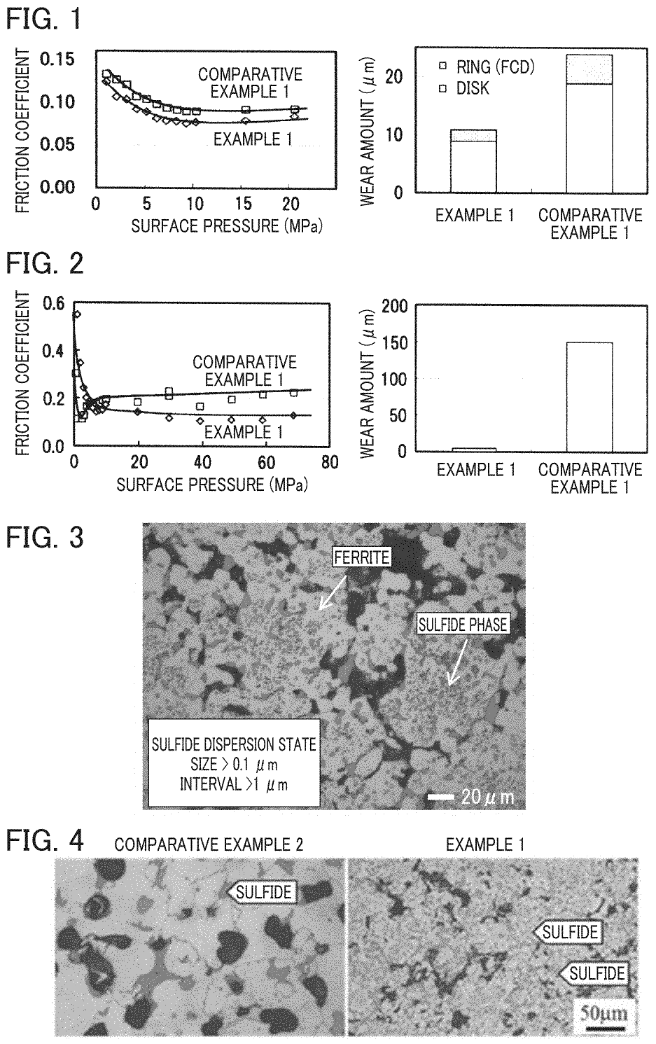

The results are illustrated in FIG. 1. As illustrated in FIG. 1, the sintered member of Example 1 has a friction coefficient that is almost equal to or lower than that of Comparative Example 1, and a sliding performance was improved. In addition, by using the sintered member of Example 1, the wear amount of a mating material was able to be reduced together with the sintered member.

“Radial Sliding Performance”

A ring-shaped sintered member with an outer diameter of 16 mm, an inner diameter of 10 mm, and a thickness of 10 mm was prepared.

A shaft made by S45C having a diameter of 9.980 mm and a length of 80 mm was prepared.

A radial crushing strength test was performed under the following conditions, and a friction coefficient was measured.

Peripheral Velocity: 1.57 m/min

Surface Pressure: 1, 2, . . . , 80 MPa

Time: 5 min at each surface pressure

Oil Type: Oil VG460 (impregnation)

The wear amount (micrometer) of the ring before and after the test was measured.

The results are illustrated in FIG. 2. As illustrated in FIG. 2, the sintered member of Example 1 has a friction coefficient that is equal to or lower than that of Comparative Example 1, and a sliding performance was improved. By using the sintered member of Example 1, the wear amount of the sintered member was able to be reduced.

FIG. 3 illustrates a metallic structure (mirror-polishing) of the sintered member of Example 1. The iron base is illustrated with white portions, the particles of the metal sulfide are illustrated with gray portions, and the pores are illustrated with black portions.

From FIG. 3, it can be observed that the particles of the metal sulfide (gray portions) are precipitated and are finely dispersed in the iron base (white portions).

### Comparative Example 2

Each raw material was mixed such that the mixture has a chemical composition shown in Table 1, and raw material powder was obtained. In the same manner as in Example 1, a ring-shaped green compact was produced and the green compact was sintered at 1130° C. in a non-oxidizing gas atmosphere to produce a sintered member of Comparative Example 2.

In the same manner as in Example 1, a chemical composition and physical properties of the base of the sintered member were measured. The results are shown in Table 1 and Table 2.

FIG. 4 illustrates metallic structures (mirror-polishing) of the sintered members of Example 1 and Comparative Example 2 for comparison. The iron base is illustrated with white portions, the particles of the metal sulfide are illustrated with gray portions, and the pores are illustrated with black portions.

From FIG. 4, when compared with Comparative Example 2, it can be observed that the particles of the metal sulfide (gray portions) of Example 1 are precipitated and finely dispersed in the iron base (white portions).

### Production Example 2

Raw material powders shown in Table 3 were prepared.

The raw material powders shown in Table 3 were blended in the combinations shown in Table 4. The blending ratio of each raw material powder was adjusted so that base compositions shown in Table 4 can be obtained.

In the same manner as in the above Production Example 1, a green compact was produced and a sintered member was produced by using the green compact.

In Example 10, a sintered member was produced by using a mixed powder of JIS standard LBC3 in the same manner as in Comparative Example 1.

For the sintered member, an area ratio of the metal sulfide, the number of particles of the metal sulfide per unit area, and the number of particles of the metal sulfide, each particle having a particle size of not more than 1 micrometer, occupying in the total number of particles of metal sulfide were measured in the same manner as in the above Production Example 1.

Further, a thrust sliding performance and a radial sliding performance of the sintered member were evaluated in the same manner as in the above Production Example 1.

In the evaluation of the thrust sliding performance, a thrust wear amount (micrometer) was obtained from the wear amount of the disc before and after the test. In the evaluation of the radial sliding performance, a radial wear amount (micrometer) was obtained from the wear amount of the ring before and after the test.

The results are shown inn Table 5.

TABLE 3
Composition of raw material powder (% by mass)

| | | | | | | | | | Fe + |
|---|---|---|---|---|---|---|---|---|---|
| | Cr | Mg | V | Ca | S | Mo | Ni | graphite | impurities |
| A-1 | | | | | | | | | Remainder |
| A-2 | 3 | | 0.5 | | | 0.5 | 5 | | Remainder |
| A-3 | 5 | | | | | | | | Remainder |
| A'-1 | 3 | 0.2 | | | | | | | Remainder |
| A'-2 | 3 | | 0.2 | | | | | | Remainder |
| A'-3 | 3 | | | 0.2 | | | | | Remainder |
| B-1 | | | | | 35 | | | | Remainder |
| B-2 | | | | | 40 | | | | Remainder |
| D-1 | | | | | 40 | 60 | | | — |

TABLE 4
Chemical composition of base

| | Raw | | | | | | | | | |
|---|---|---|---|---|---|---|---|---|---|---|
| | material | | | | | | | | | |
| | powder | S | Cr | Mo | Ca | V | Mg | Ni | C | Fe |
| Example 1 | A-1 + B-1 | 3.6 | 0.01 | | | | | | | Remainder |
| Example 2 | A-2 + B-1 | 3.6 | 2.6 | 0.3 | | 0.3 | | 4.5 | | Remainder |
| Example 3 | A-3 + B-1 | 3.6 | 4.5 | | | | | | | Remainder |
| Example 4 | A'-1 + B-1 | 3.6 | 2.7 | | | | 0.18 | | | Remainder |
| Example 5 | A'-2 + B-1 | 3.6 | 2.7 | | | 0.18 | | | | Remainder |
| Example 6 | A'-3 + B-1 | 3.6 | 2.7 | | 0.18 | | | | | Remainder |
| Example 7 | A-2 + B-2 | 4 | 2.7 | 0.45 | | 0.45 | | | | Remainder |
| Example 8 | A-2 + D-1 | 4 | 2.7 | 6.45 | | 0.45 | | | | Remainder |
| Example 9 | A-2 + | 3.75 | 2.6 | 3.45 | | 0.45 | | 4.5 | | Remainder |
| | B-1 + | | | | | | | | | |
| | D-1 | | | | | | | | | |
| Example 10 | LBC-3 | | | | | | | | | |

TABLE 5
Chemical composition of base

| | | Number | | | |
|---|---|---|---|---|---|
| | | of | | | |
| | | particles | | | |
| | | of | | | |
| | | metal | | | |
| | | sulfide | | | |
| | | havnig | | | |
| | | particle | | | |
| | | size | Area | | |
| | | of not | ratio | | |
| | Number of | more | of | | |
| | particles of | than | metal | Thrust | Radial |
| | metal sulfide | 1 μm | sulfide | wear | wear |
| | (Number/m²) | (%) | (%) | amount | amount |
| Example 1 | 4.1 × 10⁰⁸ | 0 | 20 | 30 | 25 |
| Example 2 | 1.2 × 10¹¹ | 60 | 20 | 11 | 5 |
| Example 3 | 1.9 × 10¹¹ | 93 | 20 | 10 | 5 |
| Example 4 | 1.2 × 10¹¹ | 60 | 20 | 12 | 6 |
| Example 5 | 1.2 × 10¹¹ | 60 | 20 | 11 | 6 |
| Example 6 | 1.2 × 10¹¹ | 60 | 20 | 10 | 5 |
| Example 7 | 1.1 × 10¹¹ | 65 | 23 | 8 | 3 |
| Example 8 | 1.1 × 10¹¹ | 65 | 23 | 8 | 3 |
| Example 9 | 1.2 × 10¹¹ | 63 | 21 | 10 | 5 |
| Example 10 | — | — | — | 24 | 150 |

1. An iron-based sintered sliding material, comprising:
a base containing, by mass, 3 to 15% of S, 0.2 to 6% in a total amount of at least one selected from the group consisting of Cr, Ca, V, Ti, and Mg, and a remainder of Fe and inevitable impurities, sulfide particles containing at least one selected from the group consisting of Cr, Ca, V, Ti, and Mg being dispersed in the base; and
pores.

2. The iron-based sintered sliding material according to claim 1, wherein the base further contains 0 to 10% of Ni.

3. The iron-based sintered sliding material according to claim 1, wherein the base further contains 0 to 10% of Mo.

4. The iron-based sintered sliding material according to claim 1, wherein the base further contains 0 to 1% of graphite.

5. A sliding part, wherein the iron-based sintered sliding material according to claim 1 is used.

6. A method for producing an iron-based sintered sliding material, according to claim 1, comprising:
adding a sulfur alloy powder B to an iron alloy powder A containing not less than 1% by mass in a total amount of at least one selected from the group consisting of Cr, Ca, V, Ti, and Mg such that an amount of sulfur accounts for 3 to 15% by mass of a final sintered compact;
compressing and compacting a mixed powder obtained through the adding; and
sintering a green compact obtained through the compressing and compacting at a temperature in a range from 900° C. to 1,200° C.

7. The method for producing an iron-based sintered sliding material according to claim 6, wherein the mixed powder further comprises not less than 3% by mass of at least one selected from the group consisting of a nickel powder and a nickel-iron alloy powder.

8. The method for producing an iron-based sintered sliding material according to claim 6, wherein the mixed powder further comprises 0 to 1% by mass of graphite.

9. An iron-based sintered sliding material, comprising:
a metal sulfide having not less than 20% of an area ratio, wherein
a number of particles of the metal sulfide is not less than 8.0×10¹⁰ particles/m² per unit area.

10. The iron-based sintered sliding material according to claim 9, wherein
a number of the particles of the metal sulfide, each particle having a particle size of not more than 1 micrometer, accounts for not less than 40% of a total number of the particles of the metal sulfide.

11. An iron-based sintered sliding material, comprising:
a metal sulfide having not less than 20% of an area ratio, wherein
a number of the particles of the metal sulfide, each particle having a particle size of not more than 1 micrometer, accounts for not less than 40% of a total number of all of the particles of the metal sulfide.

12. The iron-based sintered sliding material according to claim 9, wherein the metal sulfide comprises at least one selected from the group consisting of CrS, CaS, VS, TiS, and MgS.

13. A sliding part comprising the iron-based sintered sliding material according to claim 9.

14. The iron-based sintered sliding material according to claim 10, wherein the metal sulfide comprises at least one selected from the group consisting of CrS, CaS, VS, TiS, and MgS.

15. The iron-based sintered sliding material according to claim 11, wherein the metal sulfide comprises at least one selected from the group consisting of CrS, CaS, VS, TiS, and MgS.

16. The iron-based sintered sliding material according to claim 1, wherein the base further contains 0 to 10% of Ni, and 0 to 10% of Mo.

17. The iron-based sintered sliding material according to claim 1, wherein the base further contains 0 to 10% of Ni, 0 to 10% of Mo, and 0 to 1% of graphite.

18. The iron-based sintered sliding material according to claim 1, wherein the base further contains 0 to 10% of Mo, and 0 to 1% of graphite.

19. The method for producing an iron-based sintered sliding material according to claim 6, wherein the mixed powder further comprises not less than 3% by mass of at least one selected from the group consisting of a nickel powder and a nickel-iron allow powder, and 0 to 1% by mass of graphite.
